(19) United States
(12) Patent Application Publication
(10) Pub. No.: US 2004/0026516 A1
(43) Pub. Date: Feb. 12, 2004

(54) Combined flash memory card

(76) Inventors: Wen-Tsung Liu, Taipei Hsien (TW); Chia-Li Chen, Taipei Hsien (TW)

Correspondence Address: Hsu & Associates, P. O. Box 72, Nankang, Taipei, 115, TW

(21) Appl. No.: 10/216,609

(22) Filed: Aug. 12, 2002

(51) Int. Cl. G06K 19/06

(52) U.S. Cl. 235/492

(57) ABSTRACT

A combined flash memory card structure includes a circuit board with one or more flash memories and a controller. The controller is used to support, control the flash memories to exchange data with the system end. The main feature of this invention lies in that a rack structure includes a top cover, a bottom and the circuit board. The front end of the rack forms a tapered rectangular plate with multiple interface pins to support the data exchange between the flash memories thereof and the system end via a USB interface or an interface thereof.

### BACKGROUND OF THE INVENTION

1. Field of the Invention

This invention is related to a new flash memory card structure, in particular to a combined flash memory card structure, which can be connected to a system platform adopting a USB interface or serves as an independent flash memory storage device.

2. Description of the Related Art

The information products has been developed towards small size, high capacity, and multimedia such as notebook computer (NB), computer peripheral equipment, personal digital assistant (PDA), Web-PAD, digital camera and etc. Currently, there are various small storage media such as Memory Stick Card, secure Digital Card, Compact Flash Card, Multimedia Card, and Smart Media Card and etc. All above flash memory cards are products based on semiconductor storage technologies and are much better than conventional CD or diskette technologies in features such as power consumption, data preservation, data transmission rate, data access, shockproof and moisture-proof.

The universal serial interface (USB) invented in 1996 is an extended interface that can be used in various computer systems and portable devices. It is featured with high transfer rate, hot swapping, plug & play, easy installation and etc., and is widely used in various products today, such as computer systems (Desktop or Notebook), peripheral equipment (e.g. scanner, keyboard, printer, mouse and etc.), and information appliance (IA) products (e.g., MP3 Player, DSC, PDA, Removable Hard Disk and etc.). These products are in more and more consumers' favors. By now, different flash memory accessing devices (i.e., Card Reader/Card Driver or Adaptor) are available in the market such as external flash memory card drivers, built-in flash memory card drivers, flash memory card adaptors and etc.

Though consumers can buy appropriate flash memory card accessing devices to access specific flash memory cards, they are limited to certain digital products. For example, if a consumer find that no other person in his ambient environment uses a MS Card or it is not easy to get a MS Card, he/she will hesitate at buying a SONY DSC adopting MS card. On the other hand, for a consumer that has bought a SONY DSC, he will probably choose a SONY PDA.

Currently, various flash memory cards can be connected to computers or other digital products adopting a USB interface via a media-accessing device (e.g. an external flash memory driver, a built-in flash memory driver, or an adapter). Though the removable hard disk product can communicate with computers, it can't be used in other digital devices (e.g., IA products, DSCs, PDAs and etc.) that don't have a built-in USB interface. In other words, though the above devices (flash memory card and removable hard disk) can be connected to products adopting a USB interface, they can't communicate with each other. This situation brings inconvenience to consumers.

### SUMMARY OF THE INVENTION

In consideration of above problems, the inventor invents a combined flash memory card structure that can be connected to the system end adopting a USB interface or be used in products using the dedicated interface of this invention.

A purpose of this invention is to provide a structure, which has a USB socket with multi interface pins, 4 of which can serve as the signal terminals of the USB system end. On the other hand, the invention can support data transmission or exchange between it and the system end via at least an interface implemented with its multi interface pins and interface terminals of the corresponding device.

Another purpose of this invention is to provide a tapered rectangular plate on the front end of the rack thereof and especially the width thereof and the design of electric signal comply with the standard of the USB interface specification. The plate can be used to accommodate a USB interface unit so as to exchange data with the system end. The rectangle plate is only a half of a standard USB port in height but is identical to a standard USB plug in functionality. Therefore, the invention is smaller and eliminates the inconvenience and high cost burdened on customers.

### BRIEF DESCRIPTION OF THE DRAWINGS

The present invention can be more fully understood by reference to the following description and accompanying drawings, in which:

FIG. 1 is a perspective view of the combined flash memory card structure of this invention;

FIG. 2 is an exploded perspective view of the combined flash memory card structure shown in FIG. 1;

FIG. 3 is a perspective view illustrating a preferred embodiment of the combined flash memory card structure according to the present invention;

FIG. 4A is a perspective view illustrating the first step to insert the combined flash memory card structure shown in FIG. 3 to a USB rack at the system end;

FIG. 4B is a perspective view illustrating the second step to insert the combined flash memory card structure shown in FIG. 3 to a USB rack at the system end; and

FIG. 5 is a perspective view illustrating another preferred embodiment of the combined flash memory card structure according to this invention.

### DETAILED DESCRIPTION OF THE PREFERRED EMBODIMENT

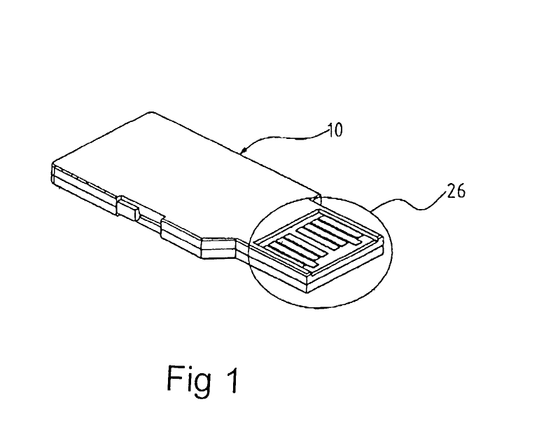

Referring to FIG. 1, a perspective view of an embodiment of the combined flash memory card structure according to this invention is illustrated. The combined flash memory card structure (10) is a new flash memory card that can be connected to and exchange data with various products adopting USB Type-A interface via the structure in the front thereof.

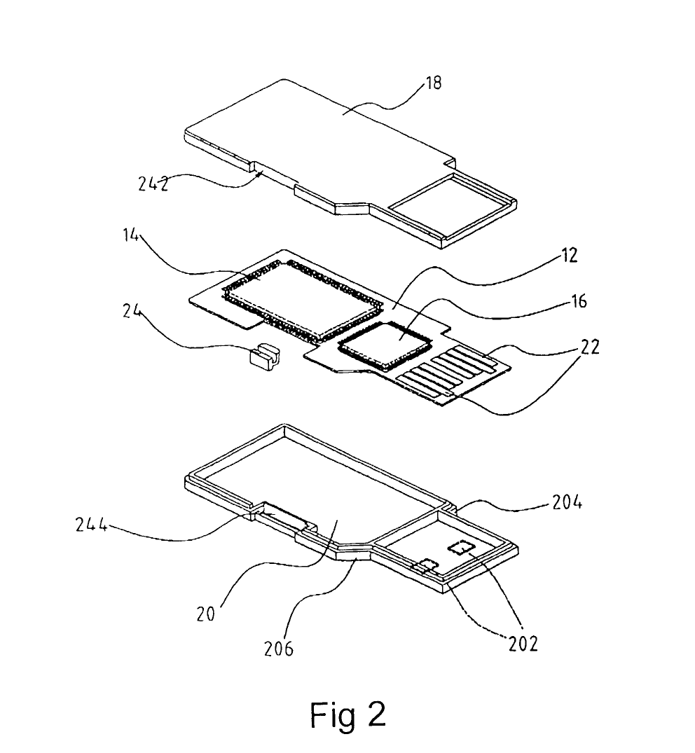

Referring to FIG. 2, an exploded perspective view of an embodiment of the combined flash memory card of this invention. The combined flash memory card structure (10) is a rack structure comprising of a top cover (18), a bottom cover (20), and a circuit board (12).

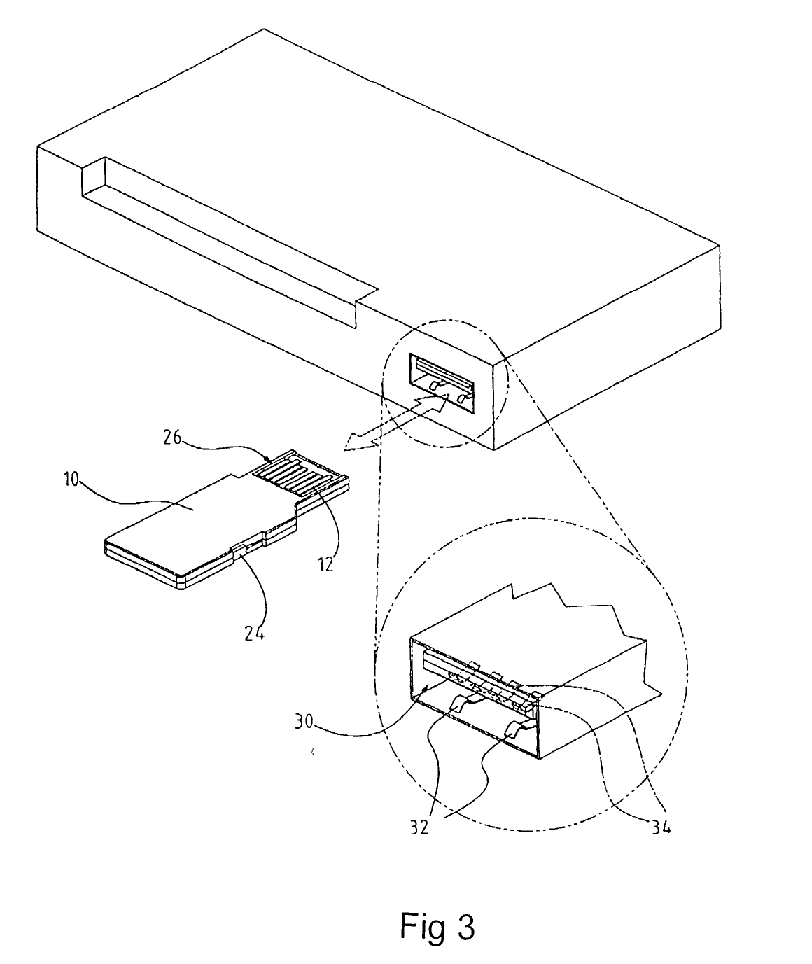

The circuit board (12) has at least a flash memory (14) and a controller (16). It is noted that only one memory is shown, however, more memories can be used. The controller (16) is provided to support, identify, and control the system end connected (see FIG. 3), and initialize corresponding circuit to implement the data exchange between the combined flash memory card structure (10) and the system end. Particularly, the rack has a tapered rectangular plate (26) (see FIG. 1) at the front side thereof and the rectangle plate (26) has eight interface pins (22) on the top thereof. Via these pins (22), the invention can exchange data with an accessing device.

As shown in FIG. 2 again, the rack has a write protection device (24) at one side thereof, which is clamped between the top clamping area (242) of the top cover (18) and the bottom clamping area (244) of the bottom cover (20). It can be switched to left or to right to control the invention in write protection mode or non-write protection mode with the assistance of the circuit arranged therein. In this way, it enables or disables the data transfer or exchange. Furthermore, the write protection device (24) can be at one side of the rack or at an appropriate position on the bottom cover (20) (not shown and it can be seen on MS Card made from SONY CO.). There are a right angle (204) and a slant (206) at both lateral sides of the tapered part of the rack at the rear end thereof, and they are designed to offer fool proof so that in correct insertion of the card caused by carelessness can be avoided.

Referring to FIG. 3, the enlarge part therein demonstrates a type A standard USB socket (30) system end, which has two positioning plates (32) and four signal terminals (34) at the center thereof. The rectangular plate (25) of this invention complies with the USB interface specification in size and circuit. There are a plurality of interface pins (12) at the top of the rectangular plate (26), i.e., the rectangular plate (26) can be inserted into the socket (30) at the system end and can transmit or exchange data with the system end on the basis of USB specification. Apparently, the two positioning holes on the bottom cover (20) (see FIG. 2) can be coupled safely with the two positioning plates (32) of the socket (30) at the system. The four interface pins (12) can contact with the four signal terminals (34) of the socket (32) at the system end to exchange data between the combined flash memory card (10) and the system end on the basis of USB specification.

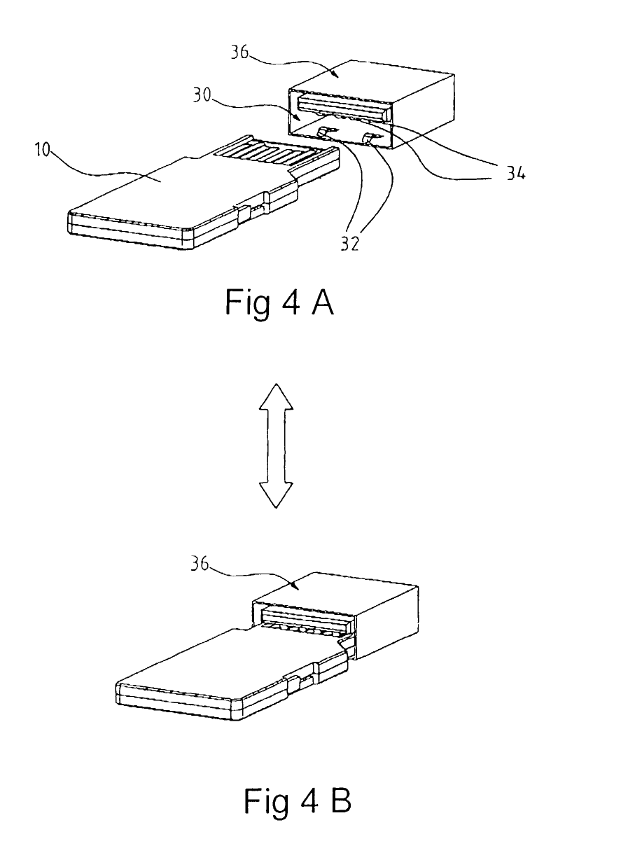

Referring to FIGS. 4A and 4B, these two figures demonstrate the first step and the second step to insert the tapered rectangular plate into a USB port (36) of the socket (30) at the system end. The length of interface pins (12) of this invention is only a half of the height of a standard USB port (36) and is different from common USB plugs. The interface pins (12) can be completely built in the port (36). In that way, the invention implements the direct connection with a standard USB interface.

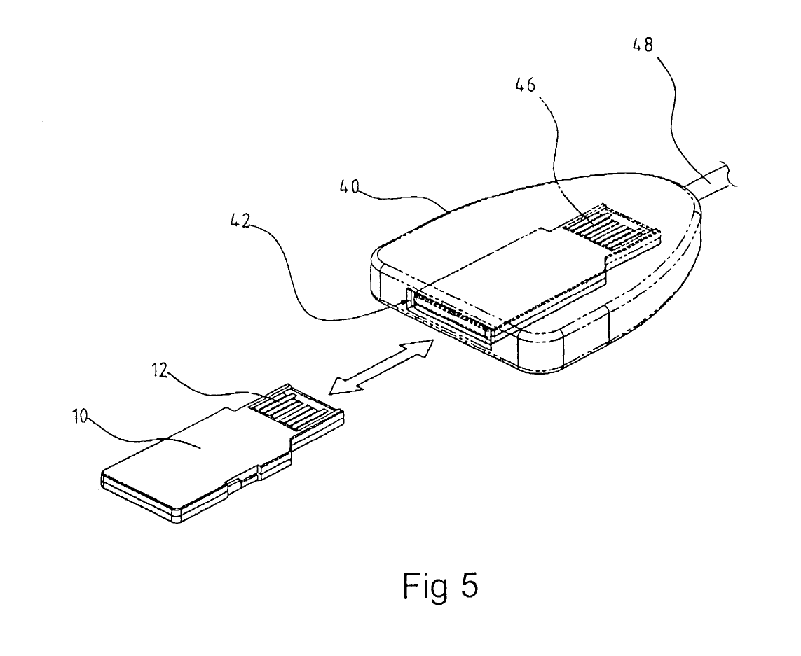

Referring to FIG. 5, another embodiment of this invention is illustrated. The flash memory card of the present invention can be used not only to comply with a standard USB connecting port but also to corresponding to access loaders (40) such as external flash memory drivers, built in flash memory drivers, flash memory adapters and various devices including a system end, peripheral equipment, an information appliance, a portable digital product and etc.). However, the loader (40) mostly has a socket (42) to accommodate the combined flash memory card (10), a plurality of interface terminals (46) to contact with the interface pins (12) assigned in this invention for performing data transmission and read, and a transmission cable (48) with USB or 1394 standard. It has to be emphasized that the combined flash memory card structure (10) of this invention might be completely built in the access loader (40) or exposed outside of the access loader (40).

It is needed to mention that this invention provides a new flash memory card specification, which can be used popularly not only in the USB interface technology but also in other fields, such as data card, network adapter, wireless network adapter, Blue sprout card, even fingerprint identification card and GPS card.

In conclusion, the combined flash memory card structure of this invention has at least the following advantages:

1. This invention is a new flash memory card structure with a unit that can be inserted into a USB socket and multi interface pins. It can not only exchange data with a USB system end through the connection between its four interface pins and four corresponding signal terminals of the system end but also exchange data with the system end on the basis of another interface specification through the connection between its interface pins and corresponding signal terminals of the system end.

2. The rack of this invention is designed to have a tapered rectangular plate with a width thereof and electric signal thereof complying with standard of the USB specification. The tapered rectangular plate can be inserted into a USB port to implement data transmission and exchange. The rectangular plate of this invention is only a half of a standard USB port in height but is identical to a standard USB plug in functionality. Therefore, the invention is smaller, and eliminates the inconvenience and high cost burdened to customers.

While the invention has been described with reference to the preferred embodiments thereof, it is to be understood that modifications or variations may be easily made without departing from the spirit of this invention, which is defined by the appended claims.

1. A combined flash memory card structure, comprising:
a rack; and
a circuit board, having one or more flash memories and a controller, the controller being used for supporting, controlling the flash memories to transmit and exchange data with an interface terminal of a corresponding device;
characterized in that the rack comprises a top cover, a bottom cover to be associated with the circuit board; the rack at a front side thereof has a tapered rectangular plate and with a plurality of interface pins on a top thereof.

2. The combined flash memory card structure as defined claim 1, wherein the rack has a write protection device at a lateral side thereof being clamped between the top cover and the bottom cover; and the write protection device enables or disables the data transmission or exchange by way of a position thereof being adjusted.

3. The combined flash memory card structure as defined in claim 2, wherein the write protection device can be disposed at an appropriate position on the bottom cover and enable or disable the data transmission or exchange with adjusting the position thereof.

4. The combined flash memory card structure as defined in claim 1, wherein a tapered part of the rack at both lateral sides of a rear end of the rectangular plate has a right angle and a slant respectively for avoiding incorrect insertion of the flash memory card structure.

5. The combined flash memory card structure as defined in claim 1, wherein the rectangular plate has two positioning holes at a bottom edge thereof for being coupled to two corresponding protruding points on the socket at the system end to implement positioning function.

6. The combined flash memory card structure as claim 1, wherein the rectangle board can be inserted into a standard USB socket at the system end; in this way, the invention can exchange data with some digital products utilizing a USB interface.
